(19) United States
(12) Patent Application Publication
(10) Pub. No.: US 2004/0218232 A1
(43) Pub. Date: Nov. 4, 2004

(54) Method and apparatus for image formation from scan data and control of a scanning apparatus for the same

(76) Inventor: Misha Fishman, LeZion (IL)

Correspondence Address: Anthony Castorina, G E Ehrlich, Suite 207, 2001 Jefferson Davis Highway, Arlington, VA, 22202, US

(21) Appl. No.: 10/450,535

(22) PCT Filed: May 1, 2003
(86) PCT No.: PCT/IL03/00354

(51) Int. Cl. G06F 15/00; H04N 1/04

(52) U.S. Cl. 358/486; 358/483; 358/1.6

(57) ABSTRACT

Method and apparatus for scanning a target moving relatively to a scanner to obtain an image involves scanning at an oblique angle to the direction of motion and oversampling. The image is then created by rearranging the scanned pixels. Blur in the scan optics and other distortions are removed by a deconvolution process which is adapted for the oblique angle scanning.

### FIELD AND BACKGROUND OF THE INVENTION

The present invention relates to image formation from scan data and control of a scanning apparatus for the same and, more particularly but not exclusively, to the case in which the scanning apparatus is a satellite in orbit.

A standard method of scanning for imaging purposes scans an object or target field in such a way, that the scan direction is perpendicular to the direction of the scan array device. In addition the scan speed is adapted to take account of the fact that the scanning device moves with respect to the target during the time of the scan. That is to say the scan speed must be adjusted so that either end of the scan line represents a straight line at the target. The scan speed must compensate for the footprint of the scan. Provided the compensation is correct it is possible to generate geometrically authentic images using the scan array device. The scan array device may for example be a line array of CCD elements. is achieved by execution of the The resolution in images formed by such a scanning is limited by parameters of the optical system, for example like optical aperture and focal length and scan device properties such as pixel size.

There is thus a widely recognized need for, and it would be highly advantageous to have, a method of scanning, and of forming an image from the scanned data, which is devoid of the above limitations.

### SUMMARY OF THE INVENTION

According to one aspect of the present invention there is provided image processing apparatus for forming an image from scanned data obtained by oversampling at an oblique angle to a direction of motion, the apparatus comprising:

an input for receiving oblique angle oversampled scanned data, and

a rearranger for rearranging said oblique angle oversampled scan data into regularly arranged pixels, thereby to form a regular image. The scanned data may be obtained by any kind of scanning, including close range scanning of the kind used for digitizing images and long range scanning of the kind used to obtain digital images from satellites.

Preferably, said oblique angle has a tangent of at least one.

Preferably, said oblique angle is an angle having an integer tangent.

Preferably, said rearranger comprises a geometric mapper for geometrically carrying out one-to-one mapping of sample pixels from said oblique overscanning, onto an image pixel grid representative of an actual geometry of a scanned object, thereby to form said regular image. Preferably, said rearranger further comprises a pixel interpolator for interpolating between said oblique angle oversampled data to fill pixel positions of an image pixel grid representative of an actual geometry of a scanned object, said pixel positions being intermediate between sampled pixel positions, thereby to form an improved precision image.

The apparatus may comprise a deconvoluter connected between said input and said rearranger for deconvoluting said input data to compensate for optical distortion incurred in scanning.

Preferably, said deconvoluter is adapted to account for distortions introduced by said oblique angle oversampling.

According to a second aspect of the present invention there is provided an image processing method for forming an image from scanned data obtained by oversampling at an oblique angle to a direction of motion, the method comprising:

receiving oblique angle oversampled scanned data, and

rearranging said oblique angle oversampled scan data into regularly arranged pixels, thereby to form a regular image.

Preferably, said oblique angle has a tangent of at least one.

Preferably, said oblique angle is an angle having an integer tangent.

Preferably, said rearranging comprises geometrically carrying out one-to-one mapping of sample pixels from said oblique overscanning, onto an image pixel grid representative of an actual geometry of a scanned object, thereby to form said regular image. Preferably, said rearranging further comprises interpolating between said oblique angle oversampled data to fill pixel positions of an image pixel grid representative of an actual geometry of a scanned object, said pixel positions being intermediate between sampled pixel positions, thereby to form an improved precision image.

The method may comprise deconvoluting said oblique angle oversampled scanned data to compensate for optical distortion incurred in scanning.

Preferably, said deconvoluting comprises compensating for distortions introduced by said oblique angle oversampling.

Preferably, said deconvoluting comprises compensating for distortions introduced by said oblique angle oversampling and by optical distortion within said scanner.

According to a third aspect of the present invention there is provided a control unit for a scanning device having a scanning row direction and being in motion relative to an object being scanned, the control unit comprising an attitude controller for controlling said scanning device to orient said scanning row direction to be at an oblique angle to said motion direction.

Preferably, said scanning device further comprises a scanning rate controller to control a scanning rate such that said scanning rate is substantially decoupled from said motion relative to said object being scanned, thereby to provide oversampling of said object.

Preferably, said oblique angle is selected to have a tangent of at least one.

Preferably, said oblique angle is selected to have a tangent which is an integer number.

Preferably, said scanning device is located on one of a group comprising an aircraft and a satellite.

Preferably, said scanning device is located on one of a group comprising an aircraft and a satellite, the control unit being remotely located therefrom and comprising a transmitter for transmitting control signals to said scanning device.

According to a fourth aspect of the present invention there is provided a method of controlling a scanning device in relative motion in a first direction with an object being scanned and having a scanning row direction orientated in a second direction, the method comprising:

orientating said scanning row direction to be at an oblique angle to said first direction.

The method may comprise controlling said scanning device to scan along said row direction at a rate decoupled from a rate of said relative motion, thereby to provide oversampling of said object.

Preferably, said oblique angle is selected to have a tangent of at least one.

Preferably, said oblique angle is selected to have a tangent being an integer number.

Preferably, said scanning device is located on at least one of an aircraft and a satellite.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a control unit according to a first preferred embodiment of a scanning device of the present invention;

FIG. 2 is a simplified diagram illustrating a scanning device being used according to the prior art;

FIGS. 3A and 3B are simplified diagrams illustrating the scanning device of FIG. 2 being used in accordance with the present invention;

FIG. 4 is a simplified flow chart illustrating a method of controlling a scanning device to carry out scans in accordance with a preferred embodiment of the present invention;

FIG. 5 is a simplified diagram showing an image processing apparatus adapted to process data obtained using the method of FIG. 4;

FIG. 6 is a simplified diagram illustrating the sampling points and the various parameters relevant to the oblique hypersampling method;

FIG. 7 is a simplified diagram illustrating the rotated spectrum of the bandlimited signal upon the rotated grid fundamental region;

FIG. 8 is a simplified diagram illustrating a scanning process for an oblique angle and scanning factor combination of α=45°, s=2;

FIG. 9 is a simplified diagram illustrating scanning and interpolation geometry for the case α=45°, s=4;

FIG. 10 is a portion of an image collected at scanning angle α=45° and an hypersampling factor s=4:

FIG. 11 is the same image after interpolation and rearrangement, but without deconvolution;

FIG. 12 is the same image after deconvolution, interpolation and rearrangement

FIG. 13 is a detail of part of FIG. 11:

FIG. 14 is a detail of the same part as FIG. 11 but taken from FIG. 12;

FIG. 15 is a spectrum of the detail of FIG. 13;

FIG. 16 is a spectrum of the detail of FIG. 14;

FIG. 17 is an image showing the spectrum of approximately the same area as in FIG. 16 but after the further stages of interpolation and resampling;

FIG. 18 is a simplified diagram illustrating scanning geometry for a positive scanning angle;

FIG. 19 is a simplified diagram illustrating scanning geometry for a negative scanning angle;

FIG. 20 is a simplified diagram illustrating sampled and interpolated pixel positions in an image reconstruction matrix for a non-integer scanning angle according to the present invention;

FIG. 21 is a simplified diagram illustrating rates of change between pixels for use in interpolation;

FIG. 22 is a simplified diagram illustrating scanning geometry for a scanning angle having an integer tangent of two;

FIG. 23 is a simplified diagram illustrating scanning geometry for a positive scanning angle having a high integer tangent; and

FIG. 24 is a simplified diagram illustrating scanning geometry for a negative scanning angle having a high integer tangent.

### DESCRIPTION OF THE PREFERRED EMBODIMENTS

The present embodiments show a scanning control unit for controlling a scanning device, perhaps ground based, perhaps mounted in an aircraft, whether manned or otherwise, perhaps mounted in a satellite, to scan at an oblique angle to the direction of motion. Additionally the scanning control unit is controlled to scan at a different speed than the relative motion between the scanner and the scanned object both in the value and in the direction, so as to oversample (or down-sample) the object, so-called hypersampling. The data obtained by scanning in such a manner can then be reconstructed by a process of interpolation into an image which has a resolution which is higher (or lower) than is possible by standard scanning. A preferred embodiment also carries out a deconvolution on the image data prior to reconstruction into an image in order to compensate for distortions introduced by the scanning optics.

The principles and operation of image formation from scan data and control of a scanning apparatus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

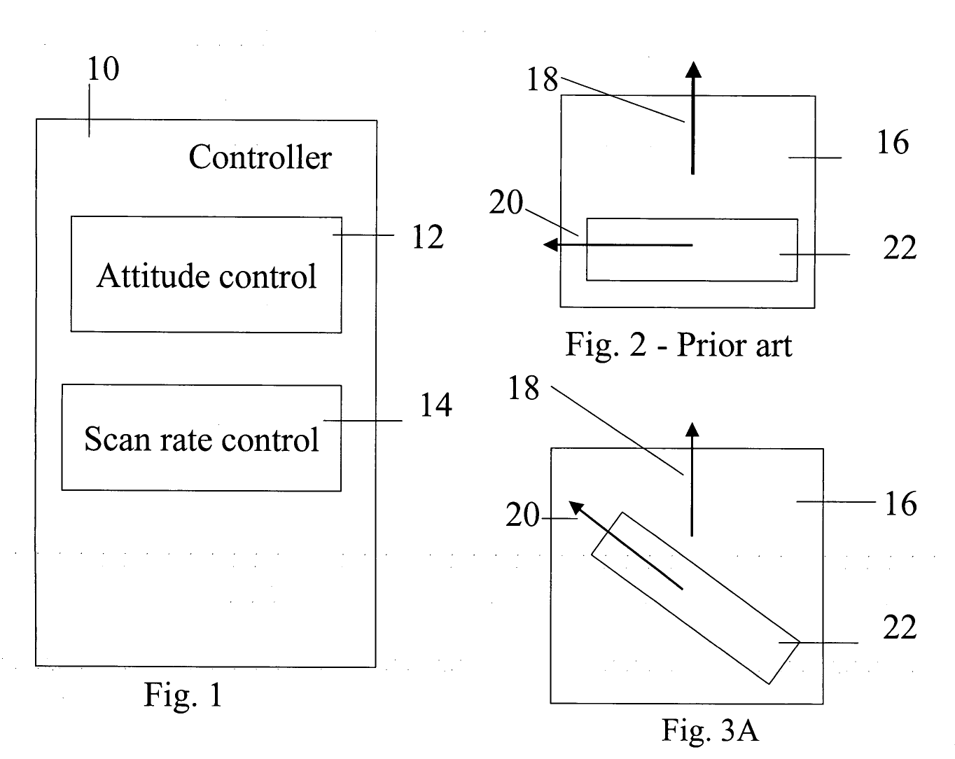

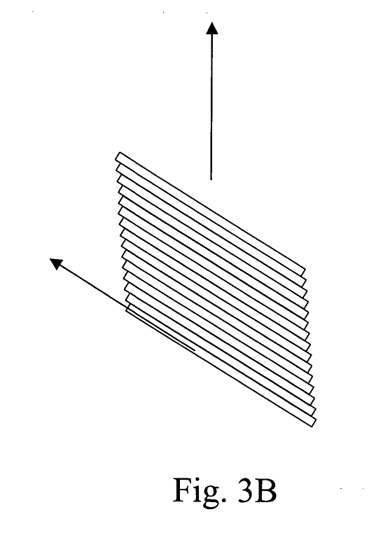

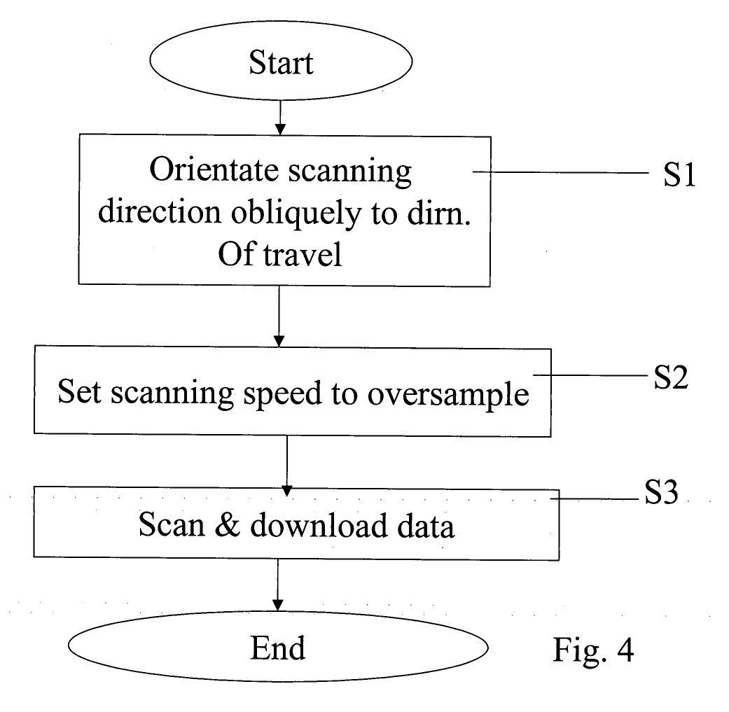

Referring now to the drawings, FIG. 1 illustrates a control unit for a scanning device. The control unit 10 has an attitude controller 12 and a scanning rate controller 14. The attitude controller 12 controls a scanning device 16 which is shown in FIGS. 2 and 3. The scanning device 16 has a direction of relative motion indicated by arrow 18 and a scanning row direction indicated by arrow 20. The scanning row direction is the direction of a row of detector pixels on a charge coupled device (CCD) 22 or like detector which carries out the scanning. FIG. 2 illustrates a conventional scanning device 16 in which the motion and scanning directions are perpendicular. FIGS. 3A and 3B illustrate scanning device 16 being controlled in accordance with a preferred embodiment of the present invention. The attitude controller 12 preferably controls the scanning device 16 so as to orient the scanning row direction to be at an oblique angle to the motion direction. The advantages of using such an oblique angle will be explained in greater detail below.

The scanning rate controller 14 preferably controls the scanning rate of the scanning device 16 so that the scanning rate is substantially decoupled from the motion relative to the object being scanned. Conventionally the two are coupled so that each object point is covered once and there is substantially no overlap or there is a regular but small and easily discounted overlap between pixels. However the scanning rate controller 14 preferably overrides the coupling so that there is substantial overlap between the detected pixels. As a result the object is oversampled, or hypersampled and interpolation between the sampled pixels becomes possible to give an improved resolution image, as will be explained in greater detail below.

One of the possibilities is to select the oblique angle to have a tangent which is an integer number. As will be explained in greater detail below, hypersampling at such angles allows imaged pixels to be rearranged directly into a regular grid without needing interpolation.

The scanning device may be a stand-alone scanner or may be located on a land vehicle or on a water craft or an aircraft or a satellite. The control unit 10 may be located with the scanning device or may be located remotely therefrom, in which case a communication link is preferably provided to relay instructions from the control unit Reference is now made to FIG. 4, which is a simplified flow chart illustrating operation of control unit 10 in controlling scanning device 16. A stage S1 comprises orientating scanning row direction 20 to be at an oblique angle to the motion direction 18. A second stage S2 involves setting the scanning speed to be decoupled from the relative motion, and specifically to scan faster than the scanner moves over the object so as to provide oversampling or hypersampling. Using the settings provided in stages S1 and S2, the scanning device is now enabled to carry out scanning in a stage S3 and to download data, in the form of raw pixels, obtained by the scanning.

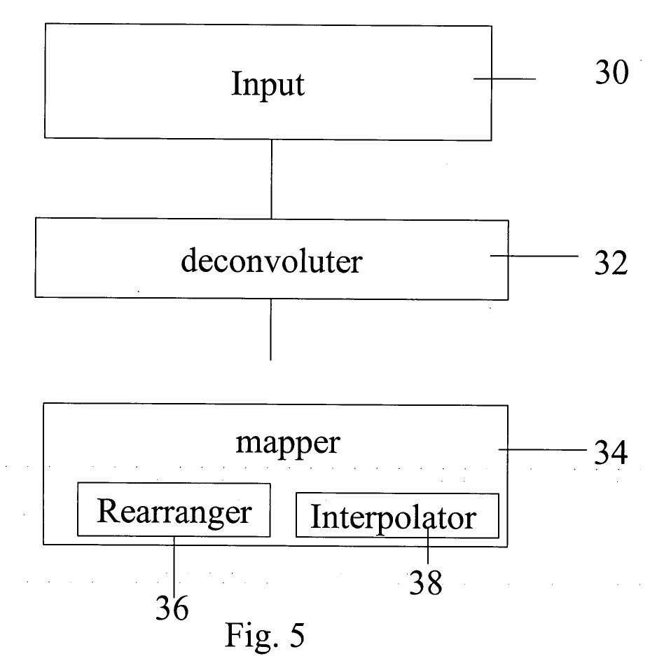

Reference is now made to FIG. 5 which is a simplified block diagram showing image processing apparatus for forming an image from the scan data provided by oblique angle oversampling as may typically result from controlling scanning as explained above. An input 30 receives the data. A deconvoluter 32 deconvolves the data to compensate for distortion or blurring in the optics of the scanner. As will be explained in greater detail below, blurring, as found in optical systems, can be modeled as a convolution, and thus can be compensated for by processing using an opposite deconvolution.

Following the deconvoluter 32 is located a pixel mapper and interpolator 34. In regular scanning, sequentially obtained pixels belong next to each other in a final image. However, in oblique scanning this is no longer true and sequentially obtained pixels not only may not belong together but may not fit exactly onto a regular grid at all, as will be explained in greater detail below. Thus a separate task of mapping of pixels onto a final image is preferably carried out. The mapping may include interpolation in cases where the sampled raw pixels do not fitting exactly onto a grid or pixel position of the final image.

Preferably the oblique angle is 0 (zero) or 45 (forty five) degrees with a hypersampling factor which is great than or equal to 2. For an oblique angle of 45 degrees and hypersampling factor of 2 the rearrangement feature to be described below may be used, while for all other hypersampling scanning angles, interpolation, as described below, is implemented.

As mentioned above, in one of the embodiments, the oblique angle may be selected from those angles having an integer tangent. Typically tangents of one (oblique angle 45 degrees and hypersampling factor 2) or two (oblique angle 63.434948822922010648427806279547 degrees and hypersampling factor 2) are preferred although higher integers work equally well. In such a case the sampled pixels generally do fit exactly onto the pixel grid of the final image. In such a case, the mapper and interpolator 34 is required only to carry out pixel rearrangement and there is no need for interpolation as a separate process.

In the following, the theoretical principles of resolution enhancement of linear array imagery by deconvolution of optical and scanning effects are first discussed. A result is first derived for conventional perpendicular scanning (Section 1.4 below) and then for oblique scanning according to embodiments of the present invention (Section 1.5 below). The discussion on oblique scanning is followed by an algorithm for linear interpolation for even-symmetrical oversampling according to a preferred embodiment of the present invention (Section 2 below), which in turn is followed by an algorithm for rearrangement in the case of integral over-sampling factor scanning according to another preferred embodiment of the present invention (Section 3 below).

### THE PRINCIPLES OF OBLIQUE HYPERSAMPLING

### Introduction

In this section, we give a theoretical analysis of the method of oblique, (two-dimensional) hypersampling of CCD array images, and its potential capability of enhancing CCD array image details.

### Hypersampling in Optical Images

The (angular) spatial sampling rate of optical sensors may be totally or partially rigidly fixed by the system design. For example in a matrix type digital sensor, the spatial sampling rate is fixed by the angular spacing of the adjacent elements. Of course, such a sensor can be designed such that the angular spacing between the elements matches the optical spread function. Suppose that an oversampled image of the latter sensor could be produced. On one hand, hypersampling, resolves higher spatial frequencies. On the other hand the image spectrum at the higher frequencies is highly masked by the optical spread function, which is still as wide as the original sampling distances. Theoretically, this problem can be resolved by deconvolution. In an ideal situation, deconvolution may produce a Dirac type sharp spread function of the size of the oversampled spatial sampling distance. But in practice, due to the image noise, higher spatial frequencies can be restored only to an extent, which produces an acceptable level of noise amplification in the image. To sum up, in the course of the following section, we always implicitly assume that deconvolution has been performed, but one should be aware of the fact that the restoration of the higher frequency spectrum is only partial.

### Hypersampling in CCD Array Images

In a CCD array system, the spatial sampling rate in the direction of the CCD array is rigidly fixed by the system design. The spatial sampling rate in the direction orthogonal to the CCD array can be, however, in principle, controlled in the course of the scanning task. Consequently, in a regular scanning plane, where the scanning direction is perpendicular to the CCD array direction, hypersampling gives access to higher spatial frequencies in the orthogonal direction to the CCD array, but no higher spatial frequencies in the CCD array direction can be resolved. The latter hypersampling method will be referred to as one-dimensional hypersampling. Again, the collection of higher frequency details through hypersampling is not straightforward because the image spectrum in these frequencies is highly masked, by the combined effect of the optical spread function and the spread of the scanning during the integration time. However, these effects can be computed from the optical characteristics of the CCD element and the scanning geometry, and corrected by means of deconvolution, keeping in mind the previously mentioned limitations of the deconvolution process.

While one-dimensional hypersampling can improve the quality of the image, there exists a mismatch between the potential for image detail in the horizontal and the vertical senses that can be provided by this method. In order to partially overcome this limitation, we analyze in the following sections the potential gain that can be obtained from hypersampling through scanning in an oblique direction to the CCD array.

### The Geometry of Oblique Hypersampling

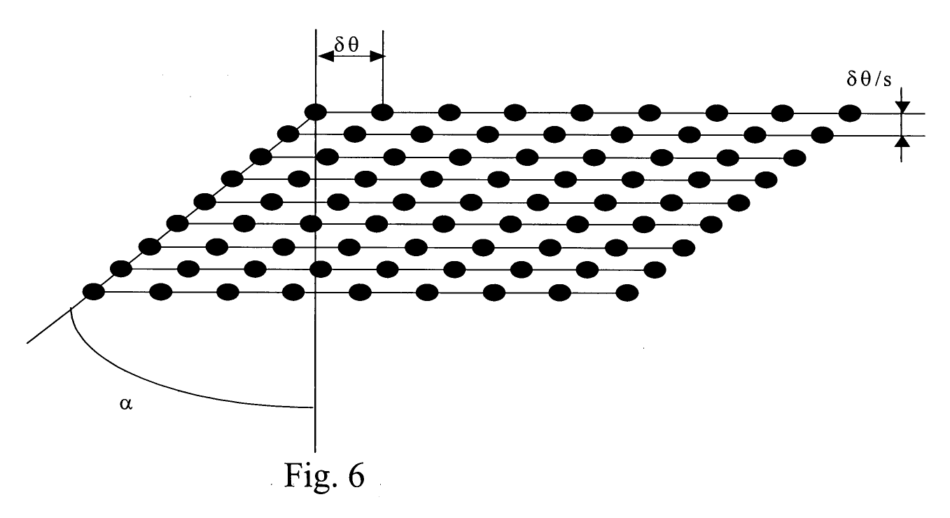

Reference is now made to FIG. 6, which describes the sampling points and the various parameters relevant to the oblique hypersampling method. In FIG. 6:

δθ=CCD element (transversal and longitudinal) angular size,

s=The hypersampling factor, and

α=The scanning angle (between the perpendicular to the CCD array and the scanning direction, in natural scanning α=0).

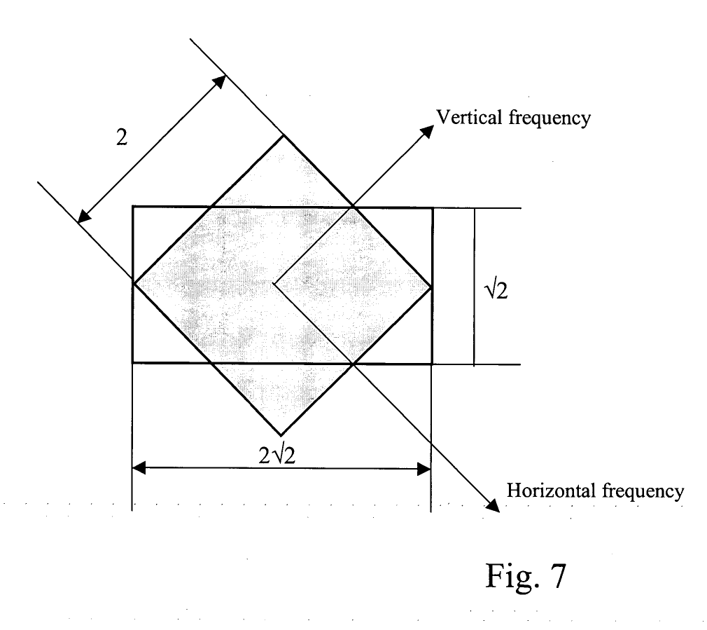

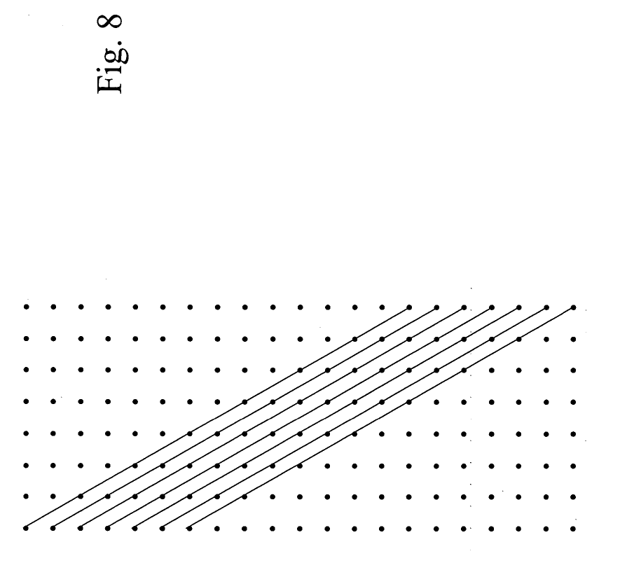

Oblique hypersampling allows partial restoration of higher frequencies in the direction of the CCD array. In order to appreciate this effect, let us consider the case: α=45°, s=4. The sampling frequency in the CCD array direction is one unit, and the sampling frequency orthogonal to the CCD array is four units. The area of the fundamental region in the frequency plane is 4×1=4. This suggests that a bandlimited signal of horizontal and vertical bandwidth of 2, should be able to be reconstructed from the sampling points. The strict answer to this question is negative. To show this, we consider the rotated grid by 45°. Due to our choice of the scanning angle and the hypersampling factor, the rotated grid is Cartesian. The sampling frequency in the horizontal direction of the rotated grid is 2\sqrt{2}, and in the vertical direction is \sqrt{2}, (of course, the area is still 4). FIG. 7, to which reference is now made, illustrates the rotated spectrum of the bandlimited signal upon the rotated grid fundamental region.

We see that three quarters of the spectrum lies within the fundamental region, while the remaining quarter of the spectrum, which is characterized by simultaneously high or low horizontal and vertical frequencies cannot be restored. Even so, the restorable spectrum is significantly wider than the natural sampling spectrum. For example one may observe that a horizontal frequency signal of twice the CCD array sampling rate and a vanishing vertical frequency can be completely restored. Furthermore, a signal varying along a line 45° with respect to the horizontal line of frequency 2\sqrt{2} times the CCD sampling rate can be completely restored.

The Effective PSF

Let us denote by I(θ,t) the ground illumination at a point displaced laterally at θ radians with respect to the (central) CCD array axis, and reached by scanning at time t. In other words, the coordinates we use to parameterize the world are angular in the transversal direction of the CCD array, and time-like in the scanning direction. Naturally by multiplying the scanning time-like coordinate by the scanning angular speed, we can reach purely angular coordinates, but we find this parameterization more convenient in taking into account the intensity integration during the integration interval.

The intensity Jₙ(t) detected at the n-th CCD element at time t, is given by:

$$\begin{matrix}{J}_{n} ( t ) = {\int }_{t - T / 2}^{t + T / 2} ⅆ q {\int }_{- δ θ / 2}^{δ θ / 2} ⅆ {θ}_{T} {\int }_{- δ θ / 2}^{δ θ / 2} ⅆ {θ}_{L} {\int }_{- ∞}^{∞} ⅆ θ {\int }_{- ∞}^{∞} ⅆ τ f ( {θ}_{n} - θ - \\ {ω}_{T} ( q - τ ) + {θ}_{T} ) \times f ( {ω}_{L} ( q - τ ) + {θ}_{L} ) \times I ( θ , τ )\end{matrix}$$

Nomenclature:

ƒ(.)=The optical line spread function, normalized to unit mass

ω_{T}=Transversal scanning angular speed

ω_{L}=Longitudinal scanning angular speed

δθ=CCD element (transversal and longitudinal) angular size

θ_{T}=CCD element transversal angular coordinate

θ_{L}=CCD element longitudinal angular coordinate

θ=Angular coordinate, parameterizing the position of the ground illumination sources in the CCD array direction.

τ=Time-like coordinate, parameterizing the position of the ground illumination sources perpendicular to the CCD array direction.

q=Time-like coordinate, parameterizing the elapsed time for the single CCD element integration

T=Integration interval

The first two integrations, from the right, represent the integration over all the ground sources (appropriately weighted by the optical PSF).

The third and fourth integrations represent the integration over the CCD element sensitive area. We mention that the model used for the optical line spread function does not include the integration over the CCD element sensitive area. The comparison of the estimated and measured PSF was made after numerical integration over the element sensitive area.

The first integration to the left represents the single CCD element integration during scanning.

It is straightforward to see that the arguments of the line spread functions ƒ(.) are the angular separations between the illuminating source and the center of the CCD element.

Assumptions

The following assumptions are implicit in the given model.

The single CCD element is square, and has uniform sensitivity over its entire area.

The single CCD element PSF is decomposable into the product of two independent line spread functions along each of its principal axes. In other words the optical PSF matrix is of unit rank.

The single CCD element integration lasts the entire time between two consecutive sampling moments (100% duty cycle).

Small angle assumption.

Kinematical Relations and Discretization

The following change of variables is performed for the evaluation of the discretized effective PSF:

$$\begin{matrix}{ω}_{L} = \frac{δ θ}{s T} \\ {ω}_{T} = \frac{δ θ tan α}{s T}\end{matrix}$$

q=t+wsT, −½s≦w<−½s

θ_{T}=xδθ, −½≦x<−½

θ_{T}=yδθ, −½≦y<−½

θₘ=mδθ

t=nT

where:

s=The hypersampling factor

α=The scanning angle (between the perpendicular to the CCD array and the scanning direction, in natural scanning α=0)

w=Dimensionless single CCD element integration time variable.

x=Dimensionless single CCD element transversal variable

y=Dimensionless single CCD element longitudinal variable

m=Collected image row number

n=Collected image column number

After the substitution of the new coordinates and the extraction of the effective PSF (digitized at the collected image sampling rates), we obtain:

$$\begin{matrix}{f}_{e} ( m , n ) = {\int }_{- 1 / 2 s}^{1 / 2 s} ⅆ w {\int }_{- 1 / 2}^{1 / 2} ⅆ x {\int }_{- 1 / 2}^{1 / 2} ⅆ y f ( ( n - \frac{m tan α}{s} - \\ w tan α + x ) δ θ ) \times f ( ( \frac{m}{s} + w + y ) δ θ )\end{matrix}$$

where:

ƒₑ(.,.)=The effective PSF

The model used for the line spread functions in the integral is the distorted Gaussian model, given in one of the previous documents, and the integrations required to produce the digitized effective PSF are performed numerically using the trapezoidal rule.

We further assume that the ground illumination is band limited within the sampling intervals, therefore, we may discretize the integration over the ground radiants, by defining:

I(m,n)=I(τ=mT,θ=nδθ)

we obtain the deconvolution equation:

$$J ( m , n ) ≡ {J}_{n} ( mT ) = {\sum }_{{m}^{′} = - ∞}^{∞} {\sum }_{{n}^{′} = - ∞}^{∞} {f}_{e} ( {m}^{′} , {n}^{′} ) I ( m - {m}^{′} , n - {n}^{′} )$$

### The Deconvolution Process

The two dimensional Fourier transform of the deconvolution equation is given by:

Ĵ(ƒₓ,ƒ_{y})=\hat{ƒ}ₑ(ƒₓ,ƒ_{y})Î(ƒₓ,ƒ_{y})

Since the deconvolution problem is ill defined and \hat{ƒ}ₑ(ƒₓ,ƒ_{y}), may even contain nulls, we apply a Tichonov type regularization, and estimate the ground illumination spectrum by:

$$\hat{I} ( {f}_{x} , {f}_{y} ) = \frac{\overline{{\hat{f}}_{e} ( {f}_{x} , {f}_{y} )} \hat{J} ( {f}_{x} , {f}_{y} )}{{\vert {\hat{f}}_{e} ( {f}_{x} , {f}_{y} ) \vert}^{2} + γ}$$

where the regularization parameter γ is chosen, such that, the noise enhancement remains acceptable.

### Interpolation of the Obliquely Oversampled Images

The collected intensity matrix is not sampled along a Cartesian grid on the ground. A process of interpolation and rearrangement is required to bring the collected data to a Cartesian grid display. In this section, we describe the process of interpolation performed on the special case of images scanned with angles satisfying tan α=nεZ. One may readily observe that if these images are oversampled by a factor s=n²+1, then the sampling points consist of a rectangular rotated grid, and only a rearrangement process is needed in order to rotate these images. FIG. 8 illustrates a scanning process for α=45°, s=2:

For hypersampling factors greater than the designated hypersampling factor, new samples are produced by interpolation to bring the image to an effective hypersampling factor of s=n²+1, then the samples are rearranged as in the first case. In our application, the interpolation is performed by two alternative metods:

Bi-cubic interpolation method

Interpolation by polyphase filtering along the perpendiculars to the scanning direction.

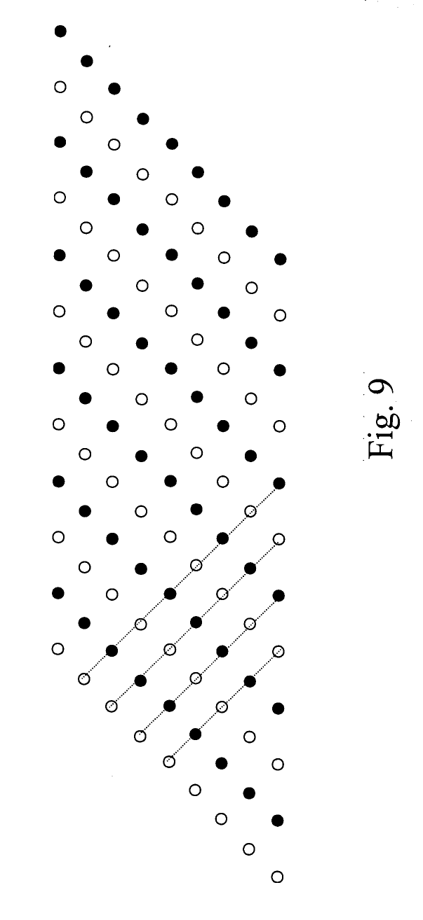

Reference is now made to FIG. 9, which illustrates the interpolation geometry, for the case α=45°, s=4. The black circles indicate the sampling points. The white circles indicate the interpolation points. The dotted lines indicate the directions along which the polyphase filtering interpolation is performed

One may observe that once the interpolated points are added, the collected data has an effective hypersampling factor of two, thus can be brought to a Cartesian grid by rearrangement.

### A Demonstration of Higher Frequency Restoration by Means of Oblique Hypersampling

In this section, we demonstrate the capability of oblique hypersampling to restore frequencies higher than the CCD spatial sampling rate.

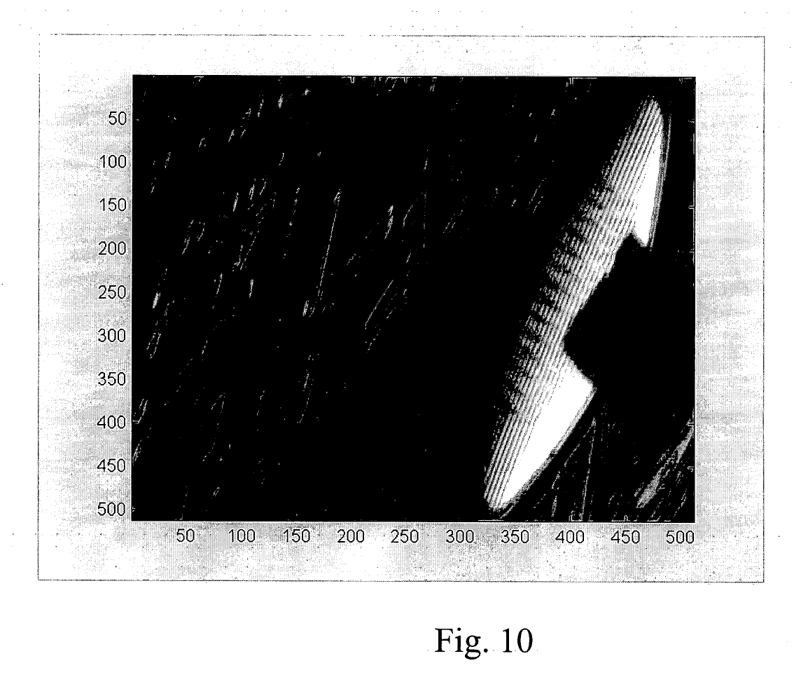

FIG. 10 shows a portion of an image collected at scanning angle α=45° and an hypersampling factor s=4.

Clearly, the image is deformed due to the use of a non-Cartesian sampling grid.

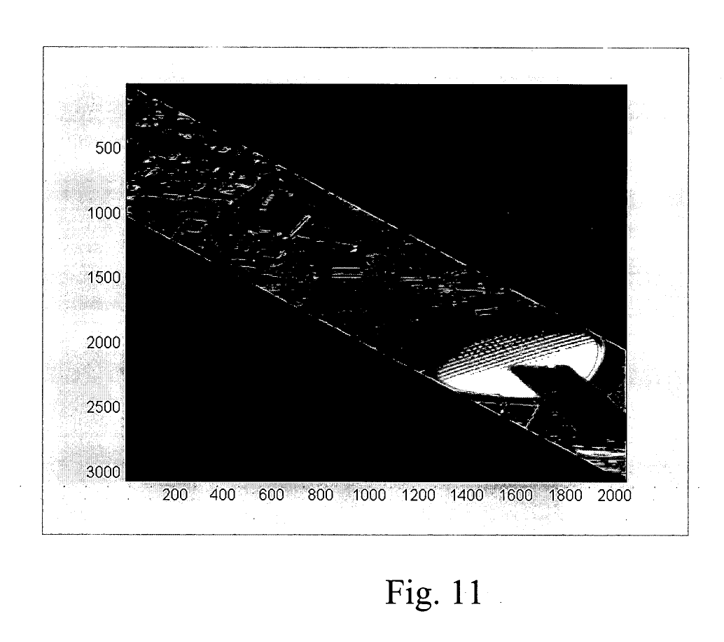

FIG. 11 shows the same image after interpolation and rearrangement, but without deconvolution.

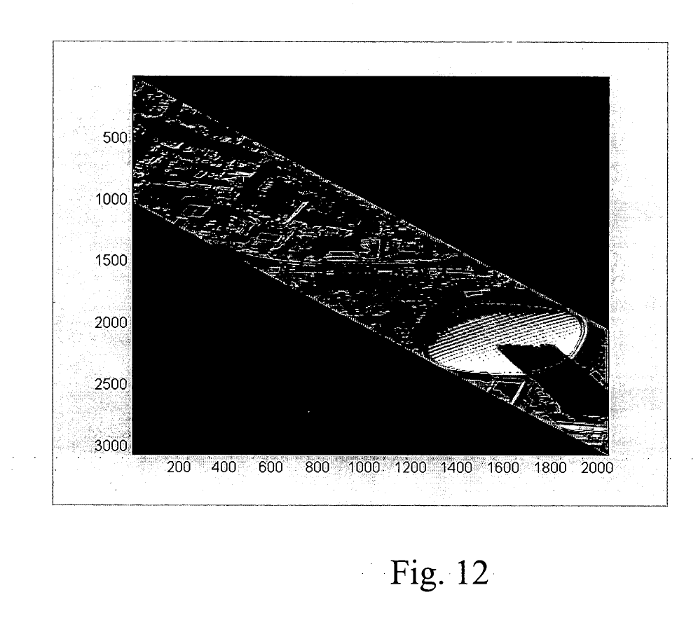

FIG. 12 shows the same image after deconvolution, interpolation and rearrangement.

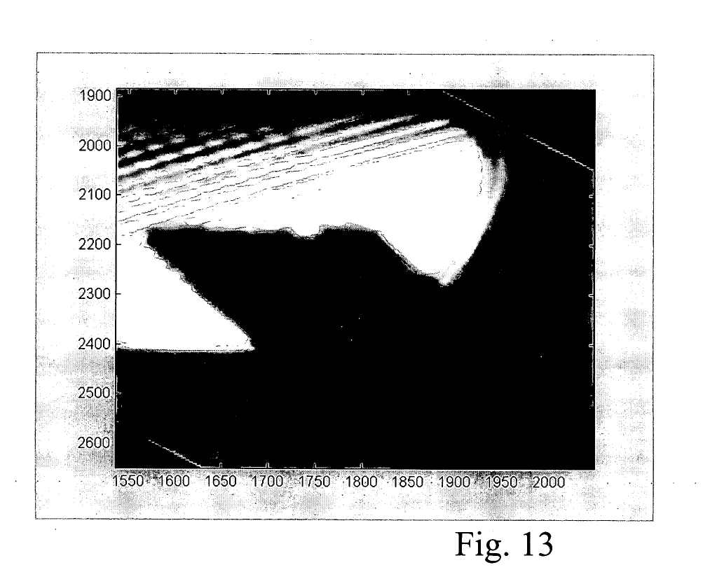

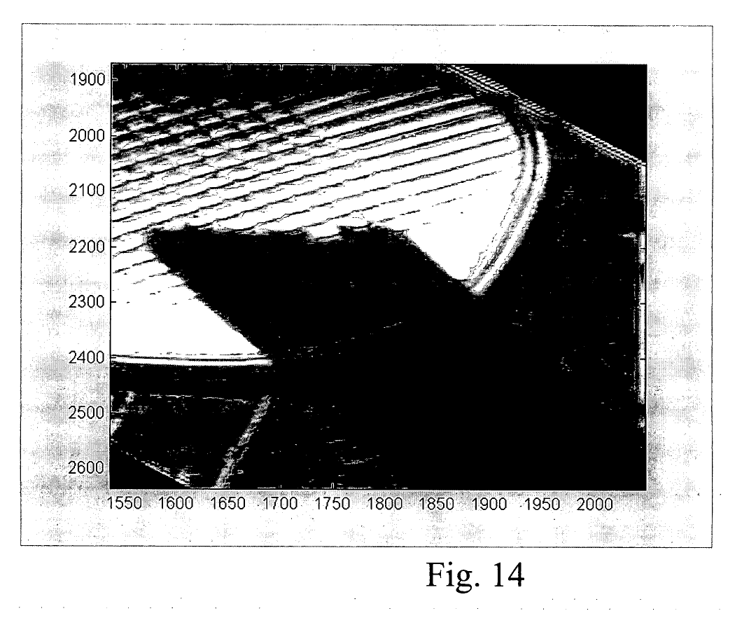

In order to appreciate the role of deconvolution, reference is now made to FIGS. 13 and 14, which are zooms taken respectively from the corresponding area of FIGS. 11 and 12 and thus show the same view with and without deconvolution.

A comparison between the two shows greater sharpness of the latter image and also enhancement of the SNR.

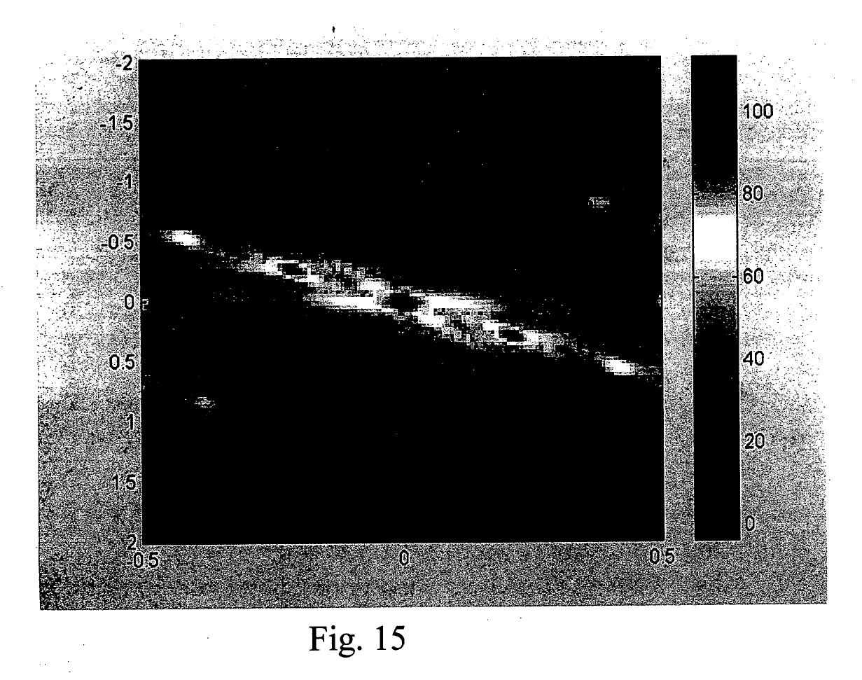

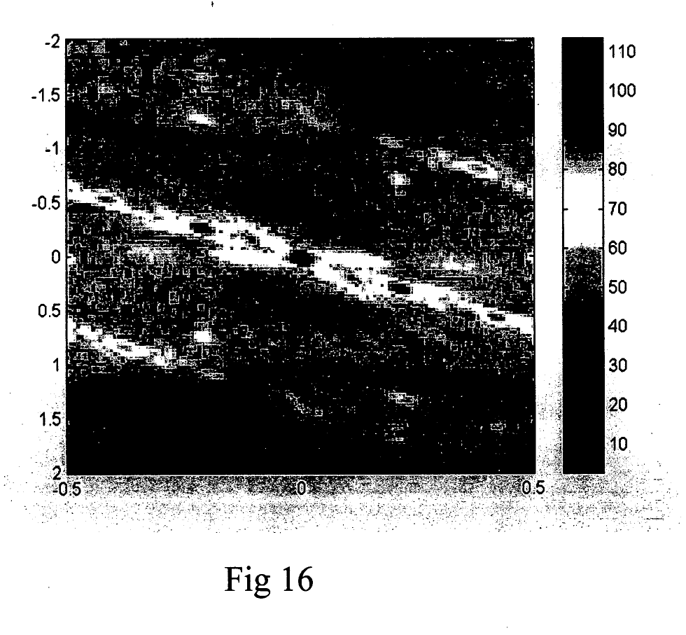

Reference is now made to FIGS. 15 and 16, which are frequency spectra of the upper right corners of the images of FIGS. 13 and 14 respectively, that is with and without deconvolution, but also without interpolation or rearrangement (in all the following spectrum images the CCD spatial sampling rate is normalized to 1): Aside from the spectrum enhancement of higher frequencies, one observes that the stronger portion of the spectrum has a tail, which has been folded at the horizontal frequency of 0.5.

Reference is now made to FIG. 17 which is an image showing the spectrum of approximately the same area as in FIG. 16 but after the further stages of interpolation and resampling. One observes clearly that the spectrum extends continuously beyond the horizontal frequency value of 0.5, and up to about 0.6, which is the Nyquist frequency of the CCD array spatial sampling rate.

### 2Linear Interpolation Algorithm for EVEN-SYMMETRICAL OVER-SAMPLING (ESOS) Scanning

2.1Scope

The following section presents an algorithm for linear interpolation of image pixels for over-sampling scanning at 45 deg and oversampling using an even oversampling (os) factor.

2.2Scanning Geometry

ESOS scanning is scanning in which the scanning direction is rotated by 45 degrees from the direction of relative motion, and the over-sampling factor, to be explained below, is even. As a result, the sampling points are located on a Cartesian grid on the ground.

The oversampling factor is defined as the number of samples perpendicular to the scanning line direction, which together cover a distance of one pixel size. A more detailed definition is given in section 3 below, “Rearrangement algorithm for integral oversampling factor scanning”.

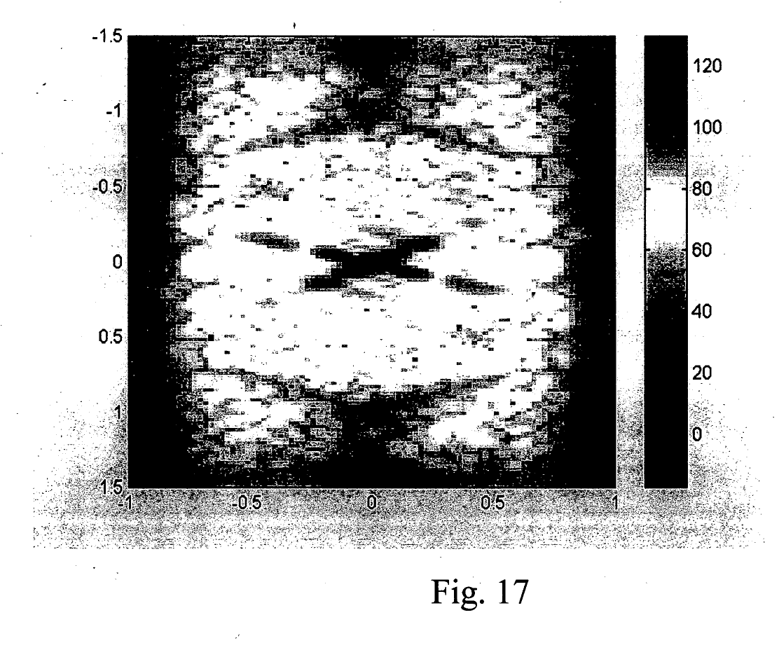

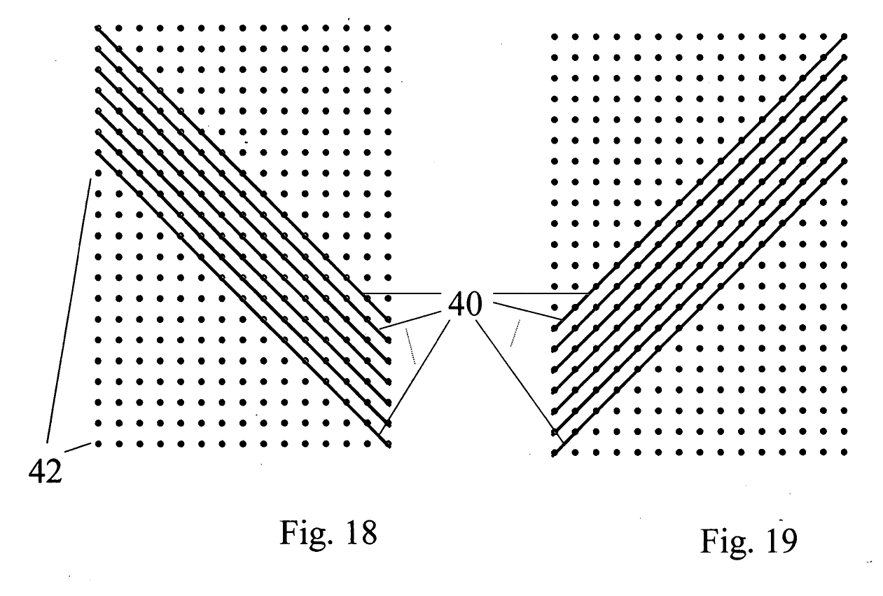

Reference is now made to FIGS. 18 and 19, which respectively illustrate scanning geometry for positive scanning angle and scanning geometry for negative scanning angle. The scan lines 40 illustrate the order in which successive pixel samples 42 are obtained, which order has to be taken into account in carrying out image reconstruction.

2.3Interpolation Algorithm

The ESOS algorithm is now given without detailed proof.

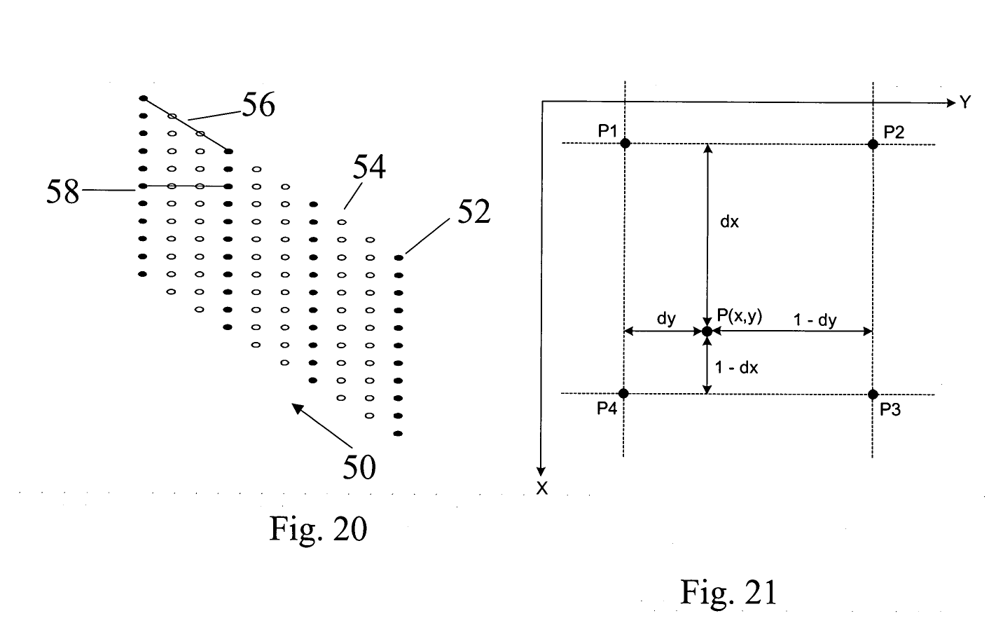

FIG. 18 shows a positive scanning angle. Re-assignment of obtained pixels to the final image matrix in the case of a positive scanning angle is now illustrated in FIG. 20 to which reference is made. FIG. 20 shows a final image matrix 50 and indicates the reconstruction geometry. Individual pixels are indicated by dots. Filled in dots 52 represent actual sampling pixel positions at maximum resolution. Empty dots 54 indicate pixel positions which do not correspond to actual pixel positions but for which information is available due to the oversampling procedure.

In use, all available rows are set, but, as far as columns are concerned, between every two consecutive sampled columns are inserted ƒₕ empty columns of pixels, where ƒₕ is selected according to the definition hereinbelow. The values of the empty columns may then be computed, and the computation is preferably achieved by interpolation between two neighboring sampled pixels 52. Interpolation can be diagonal or horizontal. Thus if the two sampled pixels used in the interpolation are located on the same scanned line, then the interpolation is known as diagonal interpolation and is as indicated by line 56. If the two sampled pixels used are located on two different scanned lines but on the same layout line, then the interpolation is horizontal interpolation, as indicated by line 58.

Notation:

The variables and data used in the rearrangement algorithm are described in Table 1:

TABLE 1
ESOS algorithm variables

| | |
|---|---|
| Input image number of rows | Nᵣᵢ |
| Input image number columns | N_{ci} |
| Output image number of rows | Nᵣₒ |
| Output image number of | N_{co} |
| columns | |
| Scanning angle | α |
| Array slope | s |
| Oversampling factor | ƒ - Must be even |
| Half of the oversampling | ƒₕ |
| factor | |
| Input image pixel intensities | I(i, j), i = 0, . . . , Nᵣᵢ − 1, j = 0, . . . , N_{ci} |
| Output image pixel intensities | J(i, j), i = 0, . . . , Nᵣₒ − 1, j = 0, . . . , N_{co} |

Input parameters and data:

The input parameters and data are given in Table 2:

TABLE 2
Input parameters and data

| | |
|---|---|
| Number of rows in the input | Nᵣᵢ |
| image | |
| Number of columns in the | N_{ci} |
| input image | |
| Input image pixel | I(i, j) , i = 0, . . . , Nᵣᵢ − 1, j = 0, . . . , N_{ci} |

The output parameters and data are given in Table 3:

TABLE 3
Output parameters and data

| | |
|---|---|
| Output image number of | Nᵣₒ |
| rows | |
| Output image number of | N_{co} |
| columns | |
| Output image pixel | J(i, j), i = 0, . . . , Nᵣₒ − 1, j = 0, . . . , N_{co} |
| intensities | |

Parameter computation:

1. Array slope:

s=|tan(α)|=1

Remark: The symbol [],denotes rounding to the nearest integer

2. Output image number of columns:

N_{co}=(N_{ci}−1)×ƒₕ+1

3. Output image number of rows:

Nᵣₒ=N_{co}+Nᵣᵢ

Image pixel computation:

1. Initiation output image pixel intensities at zero values:

J(i,j)=0, i=0, . . . , Nᵣₒ−1, j=0, . . . , N_{co}−1

2. Pixel computation—horizontal (LATERAL) interpolation:

2.1. Case 1: α>0:

j₁=j/ƒₕ; i₁=i−j₁×ƒₕ; j₂=j₁+1; i₂=i₁−ƒₕ;

J(i,j)=(I(i₁,j₁)×(ƒₕ−j_mod_ƒₕ)+I(i₂,j₂)×j_mod_ƒₕ)/ƒₕ

j_mod_ƒₕ=j−j/ƒₕ

2.2. Case 2: α<0:

j₁=j/ƒₕ; i₁=i−(N_{ci}−1−j₁)×ƒₕ; j₂=j₁+1; i₂=i₁+ƒₕ;

J(i,j)=(I)(i₁,j₁)×(ƒₕ−j_mod_ƒₕ)+I(i₂,j₂)×j_mod_ƒₕ)/ƒₕ

j_mod_ƒₕ=j−j/ƒₕ

3. Pixel computation—diagonal (SCAN) interpolation:

3.1. Case 1: α>0

j₁=j/ƒₕ; i₁=i−j; j₂=j₁+1; i₂=i₁;

J(i,j)=(I(i₁,j₁)×(ƒₕ−j_mod_ƒₕ)+I(i₂,j₂)×j_mod_ƒₕ)/ƒₕ

j₁₃ mod_ƒₕ=j−j/ƒₕ

3.2. Case 2: α<0:

j₁=j/ƒₕ; i₁=i+j−(N_{ci}−1)×ƒₕ; j₂=j₁+1; i₂=i₁;

J(i,j)=(I)i₁,j₁)×(ƒₕ−j_mod_ƒₕ)+I(i₂,j₂)×j_mod_ƒₕ)/ƒₕ

j_mod_ƒₕ=j−j/ƒₕ

4. Pixel computation—bilinear interpolation:

Referring now to FIG. 12, Pi is the digital value of the pixel “i” (for panchromatic Pi is the “gray level”):

P(x,y)=[P1×(1−dy)+P2×dy]×(1−dx)+[P4×(1−dy)+P3×dy]×dx

Columns boundaries:

Because of the structure of the final image, there is no necessity to compute pixels located outside of the coverage parallelogram since the imaging data is gathered only from the “coverage parallelogram” area—see FIG. 3a above.

The minimal (mincol) and maximal (maxcol) columns boundaries for every row can be computed as:

Case 1: α>0

for i<Nᵣᵢmincol=0;

otherwisemincol=(i−Nᵣᵢ)/s;

for i<N_{co}×smaxcol=i/s;

otherwisemaxcol=N_{co};

Case 2: α<0

for i<N_{co}×smincol=N_{co}−i/s

otherwisemincol=0

for i<Nᵣᵢmaxcol=N_{co};

otherwisemaxcol=N_{co}−(i−Nᵣᵢ)/s

### 3.Rearrangement Algorithm for Integral Over-sampling Factor Scanning

### Scope

In this section, an algorithm for rearrangement of the image pixels for integral over-sampling factor scanning is disclosed.

### Scanning Geometry

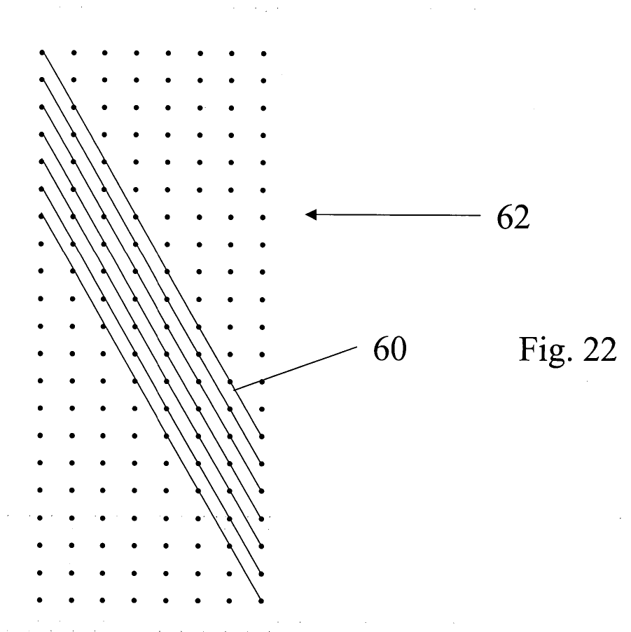

Integral over-sampling factor scanning is scanning carried out such that the scanning direction and the over-sampling factor are chosen so that the sampling points are located on a Cartesian grid on the ground. Reference is now made to FIG. 22 which shows a scanning geometry answering to the above criteria. FIG. 22 shows scan lines 60 superimposed over a pixel matrix 62 such that successive pixels picked up by the scan are in successive columns but two rows higher. By contrast with FIG. 20, all of the scanned points are part of the matrix and thus no interpolation is necessary. In the case of FIG. 22, the tangent of the scan line is two, but it could equally well be one or three. The use of an integral oversampling factor means that there is no need for interpolation to complete intermediate pixels.

### Integral Scanning Factor Scanning Geometry

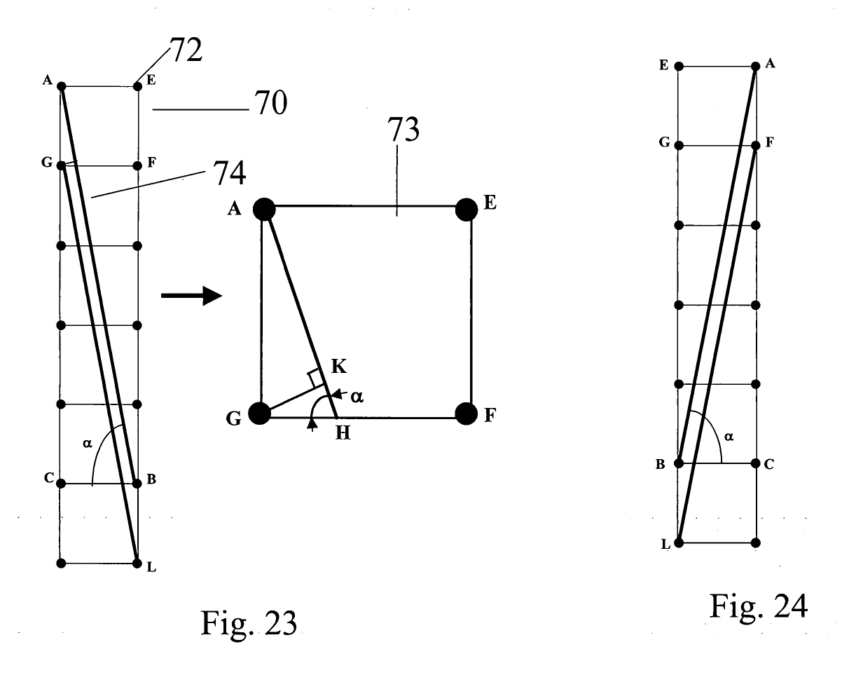

The basic parameters of integral over-sampling factor scanning geometry are depicted in FIG. 23. Part 70 of a grid of pixel points is shown in which pixel points 72 describe sampling points on the object, for example the ground. Square 73 is an enlargement of the uppermost square of the grid part 70. Part of a first sampling line 74 is the line segment: AB, where, A and B are adjacent pixel points or elements, and a first array position is assigned thereto. Likewise, an array position at a second sampling instant is assigned along second scanning line segment 76: GL. The angle α between the scanning or array direction and the horizontal line of the grid is referred to as the scanning angle. In the illustrated situation, the sign of the scanning angle is defined to be positive. FIG. 15 is an example in which the sign of the scanning angle is defined to be negative.

In integral over-sampling scanning, the tangent of α is an integer equal to or greater than one. Let us denote the array pixel size AB by p.

### Parameter Computation for Integral Scanning Factor Scanning

The following relations follow from the scanning geometry:

1. The horizontal grid side is given by:

CB=AB cos(α)=p cos(α)

2. The vertical grid side is designed to be equal to the vertical grid side:

AG=CB=p cos(α)

3. The advancement of the array perpendicular to itself per sample is given by:

GK=AG cos(α)=p cos²(α)

4. The over-sampling factor is defined as the number of samples perpendicular to the array direction required to complete one array pixel size:

$$os = \frac{p}{GK} = \frac{1}{{cos}^{2} ( α )} = 1 + {tan}^{2} ( α )$$

The numerical values of the smallest three over-sampling factors is summarized in Table 4:

TABLE 4
Parameters for the three smallest over-sampling factors

| | | | Grid pixel |
|---|---|---|---|
| Scanning | | Over- | size to array pixel |
| angle tangent | Scanning | sampling factor | size ratio |
| tan(α) | angle α | 1 + tan²(α) | cos(α) |
| 1 | 45° | 2 | 0.7071 |
| 2 | 63.4349° | 5 | 0.4472 |
| 3 | 71.5651° | 10 | 0.3162 |

### Rearrangement Algorithm

Following the geometrical description described hereinabove, the rearrangement algorithm will be given without detailed proof.

### Notation

The variables and data used in the rearrangement algorithm are described in Table 5:

TABLE 5
Rearrangement algorithm variables

| | |
|---|---|
| Input image number of rows | Nᵣᵢ |
| Input image number columns | N_{ci} |
| Output image number of rows | Nᵣₒ |
| Output image number of | N_{co} |
| columns | |
| Scanning angle | α |
| Array slope | s |
| Input image pixel intensities | I(i, j), j = 0, . . . , Nᵣᵢ − 1, j = 0, . . . , N_{ci,} |
| Output image pixel intensities | J(i, j), i = 0, . . . , Nᵣₒ − 1, j = 0, . . . , N_{co} |

### Input Parameters and Data

The input parameters and data are given in Table 2:

TABLE 6
Input parameters and data

| | |
|---|---|
| Number of rows in the | Nᵣᵢ |
| input image | |
| Number of columns in the | N_{ci} |
| input image | |
| Scanning angle | α |
| Input image pixel | I(i, j), i = 0, . . . , Nᵣᵢ − 1, j = 0, . . . , N_{ci} |

### Parameter Computation

4. Array slope:

s=|tan(α)|

Remark: The symbol [], denotes rounding to the nearest integer

5. Output image number of rows:

Nᵣₒ=s(N_{ci}−1)+Nᵣᵢ

6. Output image number of columns:

N_{co}=N_{ci}

### Image Pixel Rearrangement

5. Initiation output image pixel intensities at zero values:

J(i,j)=0, i=0, . . . , Nᵣₒ−1, j=0, . . . , N_{co}−1

6. Pixel rearrangement:

6.1. Case 1: α>0:

J(i+j s,j)=I(i,j), i=0, . . . , Nᵣᵢ−1, j=0, . . . , N_{ci}−1

6.2. Case 2: α<0:

J(i+(N_{ci}−j−1)s,j)=I(i,j), i=0, . . . , Nᵣᵢ−1, j=0, . . . , N_{ci}−1

### Output Parameters and Data

The output parameters and data are given in Table 7:

TABLE 7
Output parameters and data

| | |
|---|---|
| Output image number of | Nᵣₒ |
| rows | |
| Output image number of | N_{co} |
| columns | |
| Output image pixel | J(i, j), i = 0, . . . , Nᵣₒ − 1, j = 0, . . . , N_{co} |
| intensities | |

There is thus provided a scanning method which involves oversampling by use of an oblique angle, deconvolution taking account of the oblique angle and rearrangement of the sampling data obtained by oblique oversampling to form a regular image. Thus improved resolution of the scanned image is provided.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Image processing apparatus for forming an image from scanned data obtained by oversampling at an oblique angle to a direction of motion, the apparatus comprising:
an input for receiving oblique angle oversampled scanned data, and
a rearranger for rearranging said oblique angle oversampled scan data into regularly arranged pixels, thereby to form a regular image.

2. The image processing apparatus of claim 1, wherein said oblique angle has a tangent of at least one.

3. The image processing apparatus of claim 1, wherein said oblique angle is an angle having an integer tangent.

4. The image processing apparatus of claim 3, wherein said rearranger comprises a geometric mapper for geometrically carrying out one-to-one mapping of sample pixels from said oblique overscanning, onto an image pixel grid representative of an actual geometry of a scanned object, thereby to form said regular image.

5. The image processing apparatus of claim 1 wherein said rearranger further comprises a pixel interpolator for interpolating between said oblique angle oversampled data to fill pixel positions of an image pixel grid representative of an actual geometry of a scanned object, said pixel positions being intermediate between sampled pixel positions, thereby to form an improved precision image.

6. The image processing apparatus of claim 1, further comprising a deconvoluter connected between said input and said rearranger for deconvoluting said input data to compensate for optical distortion incurred in scanning.

7. The image processing apparatus of claim 6 wherein said deconvoluter is adapted to account for distortions introduced by said oblique angle oversampling.

8. Image processing method for forming an image from scanned data obtained by oversampling at an oblique angle to a direction of motion, the method comprising:
receiving oblique angle oversampled scanned data, and
rearranging said oblique angle oversampled scan data into regularly arranged pixels, thereby to form a regular image.

9. The image processing method of claim 8, wherein said oblique angle has a tangent of at least one.

10. The image processing method of claim 8, wherein said oblique angle is an angle having an integer tangent.

11. The image processing method of claim 10, wherein said rearranging comprises geometrically carrying out one-to-one mapping of sample pixels from said oblique overscanning, onto an image pixel grid representative of an actual geometry of a scanned object, thereby to form said regular image.

12. The image processing method of claim 8 wherein said rearranging further comprises interpolating between said oblique angle oversampled data to fill pixel positions of an image pixel grid representative of an actual geometry of a scanned object, said pixel positions being intermediate between sampled pixel positions, thereby to form an improved precision image.

13. The image processing method of claim 8, further comprising deconvoluting said oblique angle oversampled scanned data to compensate for optical distortion incurred in scanning.

14. The image processing method of claim 6 wherein said deconvoluting comprises compensating for distortions introduced by said oblique angle oversampling.

15. The image processing method of claim 6, wherein said deconvoluting comprises compensating for distortions introduced by said oblique angle oversampling and by optical distortion within said scanner.

16. A control unit for a scanning device having a scanning row direction and being in motion relative to an object being scanned, the control unit comprising an attitude controller for controlling said scanning device to orient said scanning row direction to be at an oblique angle to said motion direction.

17. The control unit of claim 16, wherein said scanning device further comprises a scanning rate controller to control a scanning rate such that said scanning rate is substantially decoupled from said motion relative to said object being scanned, thereby to provide oversampling of said object.

18. The control unit of claim 16, wherein said oblique angle is selected to have a tangent of at least one.

19. The control unit of claim 16, wherein said oblique angle is selected to have a tangent which is an integer number.

20. The control unit of claim 16, wherein said scanning device is located on one of a group comprising an aircraft and a satellite.

21. The control unit of claim 16, wherein said scanning device is located on one of a group comprising an aircraft and a satellite, the control unit being remotely located therefrom and comprising a transmitter for transmitting control signals to said scanning device.

22. A method of controlling a scanning device in relative motion in a first direction with an object being scanned and having a scanning row direction orientated in a second direction, the method comprising:
orientating said scanning row direction to be at an oblique angle to said first direction.

23. The method of claim 22, further comprising controlling said scanning device to scan along said row direction at a rate decoupled from a rate of said relative motion, thereby to provide oversampling of said object.

24. The method of claim 22, wherein said oblique angle is selected to have a tangent of at least one.

25. The method of claim 22, wherein said oblique angle is selected to have a tangent being an integer number.

26. The method of claim 22, wherein said scanning device is located on at least one of an aircraft and a satellite.
